(19) United States
(12) Patent Application Publication
(10) Pub. No.: US 2025/0285822 A1
(43) Pub. Date: Sep. 11, 2025

(54) ELECTROMAGNET CONTACT DEVICE

(71) Applicant: YM Tech Co., Ltd., Cheongju-si (KR)

(72) Inventors: Hong Gi KIM, Cheongju-si (KR); Hyun Kil CHO, Cheongju-si (KR); Seung Min LEE, Cheongju-si (KR)

(73) Assignee: YM Tech Co., Ltd., Cheongju-si (KR)

(21) Appl. No.: 19/216,549

(22) Filed: May 22, 2025

Related U.S. Application Data
(63) Continuation of application No. PCT/KR2023/019011, filed on Nov. 23, 2023.

(30) Foreign Application Priority Data
Nov. 24, 2022 (KR) 10-2022-0158893

(51) Int. Cl. H01H 50/36; H01H 50/44

(52) U.S. Cl. CPC H01H 50/36; H01H 50/44

(57) ABSTRACT

Provided is an electromagnet contact device including a coil wound around a bobbin, a movable core that is driven by the coil in an axial direction, a pair of fixed contacts for applying direct current (DC) power, a movable contact table that operates in conjunction with the movable core and is movable up and down reciprocally so as to come into contact with the pair of fixed contacts, a yoke including a magnetic material and configured to surround at least a portion of the exterior of the coil, a yoke plate fixedly disposed on an upper side of the yoke, a fixed core including a magnetic body and passing through a center portion of the bobbin and fixedly disposed by the yoke, and a permanent magnet in a ring shape disposed on an upper side of the fixed core.

### CROSS-REFERENCE TO RELATED APPLICATIONS

This application is a continuation of International Application No. PCT/KR2023/019011 filed on Nov. 23, 2023, which claims priority to Korean Patent Application No. 10-2022-0158893 filed on Nov. 24, 2022, the entire contents of which are herein incorporated by reference.

### TECHNICAL FIELD

The disclosure relates to an electromagnet contact device, and more particularly, to an electromagnet contact device having a structure for improving the attractive force of a movable core by summing the magnetic flux of an electromagnet and the magnetic flux of a permanent magnet.

### BACKGROUND ART

Direct current (DC) switch contact devices may be used in DC transportation systems using battery energy, such as electric vehicles, slow chargers, and rapid-charging devices. Recent energy storage devices, electric buses, and rapid-charging systems require high reliability due to battery fires, etc. Contact reliability of contacts is very important for ensuring human lives and human safety and for ensuring safety through accurate control of battery systems.

DC switch contact devices have become larger in product size due to a recent increase in through-current, contact reliability in which a contact part of a movable contact table contacts a contact part of a fixed contact is required, and a contact device prepared for a short circuit of a battery is necessary. There are many constraints on application to electric vehicles, including performance, safety, size, weight, and operating power consumption. An electromagnetic repulsion between contacts due to a short-circuit current has a repulsive force greater than the compressive force of a contact pressure spring of the contacts. The attractive force of an electromagnet due to an exciting current of coils exceeds the limit of a contact pressure spring and opens contacts due to an electromagnetic repulsion caused by a short circuit, making it difficult to cooperate with protection of electrical safety devices, such as damage to the product, explosion, and fire.

This problem causes usage of inefficient products that increase power consumption of an excitation coil to increase the excitation power of a coil and the contact pressure of a contact and increase the contact pressure spring of the contact, thereby increasing the attractive force of a moving core and increasing the contact pressure spring.

In a general DC relay contact device, when electricity is applied to a coil by using an electromagnet of the coil, a movable core moves in an axial direction due to excitation of the electromagnet, and, by linking a movable contact table to a shaft pin integrally connected to the movable core, a movable contact and a fixed contact come into contact each other while the movable contact table is reciprocating up and down, thereby connecting an electrical circuit. When power to the exciting coil is cut off, the movable contact table in contact with the fixed contact returns due to restoration of a return spring compressed downward in the axial direction, so that the electrical circuit may be cut off.

In conventional DC contact devices, an electromagnet is created by winding a coil on a bobbin, and a permanent magnet is disposed on a movable core or fixed core made of a magnetic material, or an auxiliary yoke of a magnetic material is created on a magnetic pole surface of the permanent magnet, and a permanent magnet is disposed on center portions of the fixed core and the movable core, so that a leakage magnetic flux of the permanent magnet is generated. In addition, the magnetic flux of the ring-shaped permanent magnet arranged at a constant interval from the movable core reciprocating in the axial direction while maintaining a constant distance (gap) between the fixed core and the movable core does not exhibit optimal efficiency. Moreover, a used leakage magnetic flux is high due to a combined magnetic flux of magnetic fluxes generated by the electromagnet made of a coil and the permanent magnet, and the number of component parts used and the number of workers increase.

Furthermore, in order to increase an attractive force of the movable core, a primary coil and a secondary coil are wound on the same bobbin, and the primary coil operates the movable core by allowing a large current to flow in a short period of time when operating, and. when the movable core is adhered to the fixed core, the secondary coil takes charge of only a sustainable current, and the primary coil is cut off. To implement these primary and secondary coils, electronic components or auxiliary contacts are used for switching, or a control device including pulse width modulation (PWM) electronic components are also used to reduce energy.

In addition, in recent years, to ensure a compact size and safety of high-voltage relays for electric vehicles, a contact device is made in a sealed contact box, and a sealed contact device that blocks an arc from being released to the outside when contacts are opened and closed has been required. Accordingly, a structure is being developed, that seals an insulating gas inside a sealed contact device to prevent battery fires or protect renewable energy devices, and that is easy to be blocked due to rapid induction, cooling, and spreading of an arc by using a permanent magnet for arc driving.

An electromagnet in conventional contact devices is manufactured and used by increasing the operation and attractive force of a movable core by increasing a product according to a flowing rated current and increasing the size of an excitation coil disposed inside the product. In addition, in order to increase the volume and contact pressure of a movable contact table, a fixed core, a bobbin, and a movable core must be increased in proportion to a current flowing through the movable contact table, so a contact device based on a method of increasing an excitation current due to a vertical reciprocating movement of the movable core has been used.

Therefore, a new economical contact device is required that reduces an overall product size and power consumption by implementing a maximum combined magnetic flux through an efficient arrangement structure of a permanent magnet and an electromagnet.

### DESCRIPTION OF EMBODIMENTS

### Technical Problem

Provided is a miniaturized electromagnet contact device capable of securing a stronger attractive force of a movable core by using a combined magnetic flux of the magnetic flux of an excitation coil and the magnetic flux of a permanent magnet, as a method for miniaturizing an electromagnet and reducing power consumption.

Also, provided is a structure of a contact device that utilizes a combined magnetic flux in an operation of a movable core by combining a magnetic flux generated from a coil and a magnetic flux of a permanent magnet due to application of a rated voltage to the coil, increases an initial attractive force of the movable core and a holding force after the operation of the movable core, reduces power consumption, reduces the size, miniaturizes an electromagnet device of an electromagnet of an excitation coil with an increased attractive force and a permanent magnet, and effectively utilizes a combined magnetic flux of a magnetic flux Φ1 of the electromagnet and a magnetic flux Φ2 of the permanent magnet.

Also, provided is a contact device used in charging and discharging a battery, the contact device being capable of increasing a capacity by increase the volume of a connected contact table due to an increase in a contact force between a fixed contact and a movable contact table, thereby increasing a compressive force of a contact pressure spring that maintains a contact pressure, and being capable of suppressing a repulsive force generated between contacts due to a short circuit of a battery by increasing the contact pressure.

Also, provided is a contact device that generates a large attractive force overlapping the magnetic fluxes of an electromagnet and a permanent magnet by inserting the permanent magnet in a circular ring shape into an upper end of an assembled fixed core, adhering the permanent magnet to a yoke plate, attaching and assembling a washer in a circular plate shape formed of a magnetic material to an upper portion of the permanent magnet, fitting the yoke plate onto left and right sides of a yoke, and fixing the yoke plate to a bending portion of the yoke.

Also, provided is a contact device having a structure of minimizing economical power consumption and a volume compared to a through-current in a sealed contact device included in a high-voltage contact switch device applicable to renewable energy, electric vehicles, direct current power control, battery power control, etc., thereby reducing the fuel efficiency of electric vehicles.

The technical problems of the disclosure are not limited to the above-mentioned contents, and other technical problems not mentioned will be clearly understood by a person skilled in the art from the following description.

### Technical Solution

According to an embodiment of the disclosure, an electromagnet contact device includes a coil wound around a bobbin, a movable core that is driven by the coil in an axial direction, a pair of fixed contacts for applying direct current power, a movable contact table that operates in conjunction with the movable core and is movable up and down reciprocally so as to come into contact with the pair of fixed contacts, a yoke including a magnetic material and configured to surround at least a portion of the exterior of the coil, a yoke plate fixedly disposed on an upper side of the yoke, a fixed core including a magnetic body and passing through a center portion of the bobbin and fixedly disposed by the yoke, and a permanent magnet in a ring shape disposed on an upper side of the fixed core. A magnetic flux generated by the coil and a magnetic flux generated by the permanent magnet increase an attractive force of the movable core.

The permanent magnet may have a magnetized surface in the axial direction. The permanent magnet may be attached to a cross-section of an upper side of the fixed core. A washer in a plate shape made of a magnetic material may be attached to an upper portion of the permanent magnet. A closed circuit of a magnetic flux may be formed without a gap between the yoke, the fixed core, the permanent magnet, the washer, and the yoke plate.

### Effects of Disclosure

According to the disclosure, a contact device capable of remotely controlling a switch using an electromagnet is configured to increase a contact pressure of a contact and minimize power consumption by optimally combining an excitation coil of a switch contact device used during battery charging/discharging with a permanent magnet to enhance the attractive force of a movable core. A movable contact, which operates due to the power of a coil by using the magnetic fluxes of the electromagnet and the permanent magnet, may secure the contact reliability of the contact and an increase in the current flowing through the contact, by connecting an increased attractive force to the contact pressure of the contact even with low power consumption of a manipulation coil.

In addition, according to the disclosure, a contact device may be provided in which a ring-shaped permanent magnet is adhered and bonded to an upper cross-section of a fixed core to thereby reduce the leakage magnetic flux of the permanent magnet, and a coil and a permanent magnet are included and a contact pressure of a contact with an increased operating attractive force is increased.

Moreover, according to the disclosure, respective polarities of an excitation coil manipulating a coil part with direct current power and a permanent magnet need to be arranged in the same direction, and a contact device may be implemented that does not operate when the power of the excitation coil is input to a contact device having a directionality of a current due to the polarity of the permanent magnet arranged inside, by reversing the polarity of a terminal drawn from a coil.

Furthermore, according to the disclosure, a contact device may be provided in which, when power is applied to an excitation coil, a magnetic flux forms a loop and a closed circuit from a fixed core to a movable core inside, from the movable core to a yoke plate, and from the yoke plate to the left and right of a yoke, so that a maximum attractive force may be exerted to the movable core, and, at this time, a portion of the magnetic flux forms a loop of a magnetic closed circuit starting from the N pole of a permanent magnet to the movable core, the yoke plate, and the S pole of the permanent magnet, so that an adhering holding force of the movable core to the yoke plate may be doubled.

The effects of the disclosure are not limited to the above-mentioned contents, and other effects not mentioned will be clearly understood by a person skilled in the art from the following description.

### DESCRIPTION OF THE DRAWINGS

FIG. 1 is an assembly view for describing the structure of a direct current (DC) contact device, according to an embodiment of the disclosure.

FIG. 2 is a cross-sectional view for explaining structures and operations of an excitation coil part and a permanent magnet according to an embodiment of the disclosure.

FIG. 3 is a view for explaining the assembly sequence of an electromagnet including an excitation coil and a permanent magnet that exerts a composite force of magnetic fluxes.

FIG. 4 is a drawing for explaining a structure in which a fixed core is adhered to a permanent magnet disposed on an end of a fixed core in an axial direction by a magnetic force of the permanent magnet in the axial direction of the permanent magnet, a plate washer made of a magnetic material is attached to the permanent magnet and a yoke plate is fixed to a yoke.

FIGS. 5A through 5H are diagrams for explaining the force of a combined magnetic flux generated due to a magnetic flux 1 of an electromagnet and a magnetic flux Φ2 of a permanent magnet according to an operating distance of a movable core, according to an embodiment of the disclosure.

FIG. 6 is a view for explaining a closed loop of a combined magnetic flux of a magnetic flux Φ1 generated by an excitation current of a coil and a magnetic flux Φ2 of a permanent magnet through a movable core according to an embodiment of the disclosure.

FIG. 7 is a diagram showing a closed loop of a magnetic flux Φ2 distribution by a permanent magnet before power is applied to a coil.

FIG. 8 is a diagram showing a magnetic flux distribution by the magnetic flux of an electromagnet without a permanent magnet in an initial state when power is applied to a coil.

FIG. 9 is a diagram showing a magnetic flux distribution in which the magnetic flux Φ1 of the coil part and the magnetic flux Φ2 of the permanent magnet are synthesized to double the attractive force by applying power to the coil, according to an embodiment of the disclosure.

### DETAILED DESCRIPTION

The disclosure will now be described more fully with reference to the accompanying drawings, in which exemplary embodiments of the disclosure are shown. The present disclosure may, however, be embodied in many different forms and should not be construed as being limited to the embodiments set forth herein.

The terminology used herein is for the purpose of describing particular embodiments only and is not intended to limit the disclosure. As used herein, the singular forms “a”, “an” and “the” are intended to include the plural forms as well, unless the context clearly indicates otherwise.

It will be understood that the terms “comprises” and/or “comprising,” when used in this specification, specify the presence of stated components, steps, operations, and/or elements thereof, but do not preclude the presence or addition of one or more other components, steps, operations, and/or elements thereof.

While such terms as “first”, “second”, etc., may be used to describe various components, such components must not be limited to the above terms. The above terms are used only to distinguish one component from another. In the description, certain detailed explanations of the related art are omitted when it is deemed that they may unnecessarily obscure the essence of the disclosure.

In addition, the components shown in the embodiments of the present disclosure are shown independently to indicate different characteristic functions, and do not mean that each component is a separate component. In other words, for convenience of description, each component is listed and described as each component, and at least two components of each component may be combined to form one component, or one component may be divided into a plurality of components to perform a function. The integrated and separate embodiments of each component are also included in the scope of the present disclosure without departing from the essence of the present disclosure.

Hereinafter, the disclosure will be described more fully with reference to the accompanying drawings, in which exemplary embodiments of the disclosure are shown. The configuration of the disclosure and the effect of the action thereof will be clearly understood through the following detailed description.

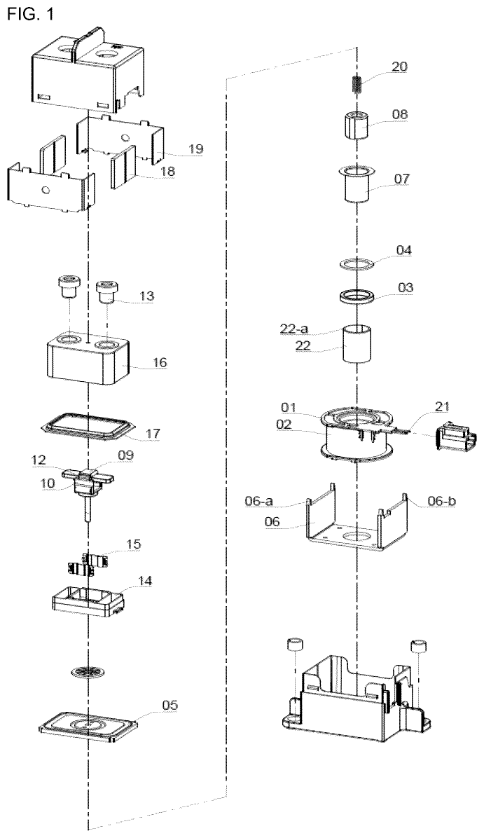

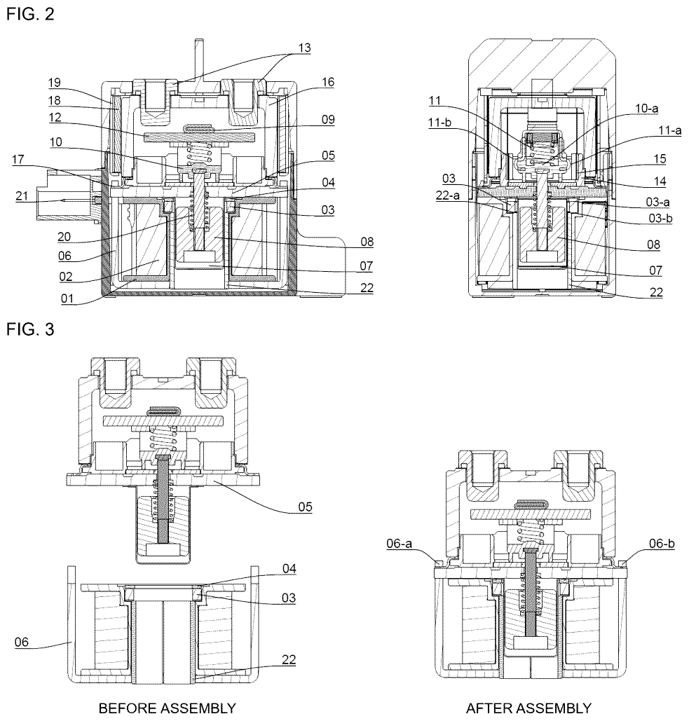

FIG. 1 is an assembly diagram for explaining the configuration of a direct current (DC) contact device according to an embodiment of the disclosure, and FIG. 2 is a cross-sectional diagram for explaining the configurations and operations of an excitation coil part and a permanent magnet according to an embodiment of the disclosure.

Referring to FIGS. 1 and 2, in an assembly process of a contact device according to an embodiment of the disclosure, a coil 02 may be wound around a bobbin 01 so that a start line and an end line of an electric coil winding part are electrically connected to a coil terminal 21 to create an electromagnet, and a fixed core 22 integrally fixedly arranged on the center of a yoke 06 in a center inner groove of the bobbin 01 may be fitted to a lower center of the bobbin 01 on which the coil has been wound. The fixed core 22, which is a hollow cylindrical pipe structure passing through the center of the bobbin 01, may include a magnetic material.

A permanent magnet 03 in a ring shape may be attached to a cross-section 22-a at an upper side of the fixed core 22 in a vertical direction, namely, an axial direction, and a washer 04 in a plate shape made of a magnetic material may be attached and assembled to an S pole 03-a, which is an upper magnetic pole surface of the permanent magnet 03 in the axial direction. An upper surface of the permanent magnet 03 may be the S pole 03-a and a lower surface may be an N pole 03-b, and thus the permanent magnet 03 may have a magnetization surface in the axial direction of the fixed core 22 and a movable core 08. The permanent magnet 03 may use various types of permanent magnets. Examples of the permanent magnet 03 may include permanent magnets made of various materials, such as ferrite-based or rare earth-based materials. The permanent magnet may be made in a shape other than a circle, such as a square or semicircle, or in several pieces, and may be formed in a shape in which the permanent magnet is adhered to an upper end of the fixed core 22 in the axial direction by its magnetic force and surrounds a cylinder 07.

In terms of the axial polarity of the permanent magnet, if a direction of the electromagnet's current is changed, it is okay for the directions of the N and S poles to be reversed.

At this time, the permanent magnet 03 may extend a length by being completely attached to the upper surface of the fixed core 22 in the axial direction without any gap and being adhered thereto by a magnetic force, and a leakage magnetic flux of the permanent magnet 03 may be prevented by attaching the washer 04 in a plate shape made of a magnetic material to an upper portion of the permanent magnet 03.

The yoke 06 includes a magnetic material and is configured to surround at least a portion of the outside of the coil 02, and a yoke plate 05 may be fixedly arranged on an upper side of the yoke 06. The yoke plate 05 and the yoke 06 may be completed by fitting the yoke plate 05 onto a left side 06a and a right side 06-b of the yoke 06 and fixing them through processing. The yoke 06 may be made of a magnetic metal, and may have, for example, a U-shape including a lower surface and both side plates. With this configuration and assembly, an excitation coil manipulation part coil including a permanent magnet may be completed. As such, a yoke assembly may be completed by making a circular groove in the center of a lower surface of the yoke 06 in a U shape made of a magnetic material and tightly fixing the fixed core 22 to the groove. In the yoke assembly, the coil 0 may be wound around the bobbin 01, start and end winding lines of the coil may be electrically connected to the coil terminal via soldering, welding, etc., and the fixed core 22 may be fitted into a through groove in the center of the bobbin 01 and assembled to the yoke 06.

The permanent magnet 03 illustrated in FIG. 2 may be attached to the fixed core 22, and the movable core 08 arranged inside the cylinder 07 of the sealed contact device may pass through the center of the cylinder 07, and a shaft pin may be fixedly arranged. The shaft pin and a movable contact table holder 09 may be combined and fixed to a movable contact table mold 10 insert-molded with plastic resin, and a pressure spring 11 may be fitted onto a pressure spring seating protrusion 10-a located on an upper side of the movable contact table mold 10 made by insert-molding, and may be compressed to integrate the pressure spring 11 into a lower protrusion of a movable contact table 12 so that assembly may be performed. The movable contact table holder 09 may have an overall n shape, and may include sliding parts 11-a that protrude in an R shape with convex surfaces on both sides. The movable contact table holder 09 may include a pair of sliding parts 11-b on lower ends of both lateral sides as shown in FIG. 2, or may include two pairs of sliding parts respectively formed on upper and lower ends and a method of increasing the attractive force of a contact point in response to an electromagnetic repulsive force generated at the contact point during battery short-circuit by overlapping a plurality of plates on the upper side of the ∩ shape.

The pressure spring 11 and the movable contact table 12 accommodated in the ∩-shaped movable contact table holder 09 of a movable contact table accommodating part are restrained by the ∩-shaped movable contact table holder 09 to prevent separation, and are operated in the axial direction by upper and lower contact pressure over-travels (O/T). When contacting a fixed contact 13, the movable contact table 12 is pushed up by compressing the pressure spring 11 by the O/T, and a compressive force of the compression spring is generated as a contact pressure at a contact portion between the fixed contact 13 and the movable contact table 12. The movable contact table holder 09 may include a magnetic metal material, and may have a structure capable of moving up and down by sliding with exposed surfaces of guide pieces 15 formed on an arc base 14 through a structure of a sliding part in the form of a protruding curved surface.

The cylinder 07 of the sealed contact device may be fixedly arranged on a lower portion of the yoke plate 05 to which the movable contact table accommodating part 09 is fixed, via airtight welding.

When the interior of such a sealed contact device is completed, a flange of a shield cup 17 fixed to a lower portion of a ceramic housing 16 is sealed with the yoke plate 05 in a hydrogen mixed gas atmosphere via welding to separate the interior from the outside, and the interior of the sealed contact device may be rendered as a sealed contact device filled with an insulating gas.

In the sealed contact device, a cylinder part may be fitted into the central groove of the coil bobbin 01 assembled to the yoke 06, and a pair of protrusions 06-a and 06-b formed integrally with the yoke 06 may be fixed to the yoke plate 05 by caulking.

A pair of permanent magnets 18 for arc extinguishing may be arranged in the vertical direction of a ceramic housing 16 on the left and right sides of a pair of fixed contacts 13 for applying DC power, the permanent magnets 18 for arc extinguishing may be rendered in a closed-circuit state by a permanent magnet holder 19 for arc extinguishing to reduce a leakage magnetic field to the outside, and a pair of permanent magnets 18 for arc extinguishing are arranged so that an arc caused by opening and closing of the contacts is induced and extended in a diagonal direction of the movable contact table 12, and thus a permanent magnets for arc extinguishing may be arranged to extinguish the arc.

According to this configuration of the disclosure, an economical DC contact device with airtight sealed insulating gas may be provided that implements weight reduction of the product by increasing an attractive force on the movable core 08 with a doubled magnetic flux by using a magnetic flux generated from the excitation coil 02 implementing low power consumption in a DC contact device and a magnetic flux of the permanent magnet 03 attached to the upper side of the fixed core 22.

Referring back to FIGS. 1 and 2, in an operation of the contact device, when coil manipulation power is applied to the coil terminal 21 extending from the excitation coil 02, a magnetic flux of an electromagnet flows from the fixed core 22 to the movable core 08 according to the principle of the electromagnet, and also a magnetic flux starting from the fixed core 22 flows to the permanent magnet 03 and moves from the permanent magnet 03 toward the movable core 08, and, eventually, the two magnetic fluxes @1 and @2 are summed to multiply and operate a magnetic attraction force, and, at the moment when the movable core 08 comes into contact with a yoke plate in an operation-stopped state, the magnetic flux 1 generated in the electromagnet by the excitation coil 02 may form a closed circuit in the order of the fixed core 22, the movable core 08, the yoke plate 05, and the yoke 06, and the magnetic flux Φ2 generated in the permanent magnet 03 may start from the N pole 03-b of the permanent magnet 03 in an inward direction of the permanent magnet 03, pass through the movable core 08 and the yoke plate 05, and flow to the S pole 03-a of the permanent magnet 03 in a closed loop.

On the other hand, when manipulation power of the excitation coil 02 is off, the movable core 08 is separated from the fixed core 22 by a recovery spring 20 and moves downwards, in contrast with the above-described operation. At this time, the movable core 08 interlocked with the movable contact table 12 may move downward so that an electrical contact of a contact may be changed to an open circuit state.

According to such an operation of open and closed circuit states, contact may be separated from the contact portion between the fixed contact 13, which is a main contact, and the movable contact table 12.

FIG. 3 is a view for explaining the assembly sequence of an electromagnet including an excitation coil and a permanent magnet that exerts a composite force of magnetic fluxes.

Referring to FIG. 3, a permanent magnet 03 in a circular ring shape may be arranged so as to be attached to an upper side of the fixed core 22 in the axial direction that is integrally coupled to the yoke 06 and fixes the lower portion of the yoke plate 05. At this time, the polarity of the permanent magnet 03 is magnetized and disposed in the axial direction. The washer 04 in a plate shape formed of a magnetic material may be inserted between the upper side of the permanent magnet 03 and the yoke plate 05, so that an effect of reducing a leakage magnetic flux of the permanent magnet 03 may be obtained.

In addition, the fixed core 22 may be fixed to the lower portion of the yoke 06, a central through portion of the bobbin 01 of the excitation coil part may be fitted and assembled to the lower portion of the yoke 06, the permanent magnet 03 may be disposed on the upper side of the fixed core 22, and the washer 04 in a plate shape and the yoke plate 05 may be seated on the left and right sides of the yoke 06 and fixed thereto by caulking, etc.

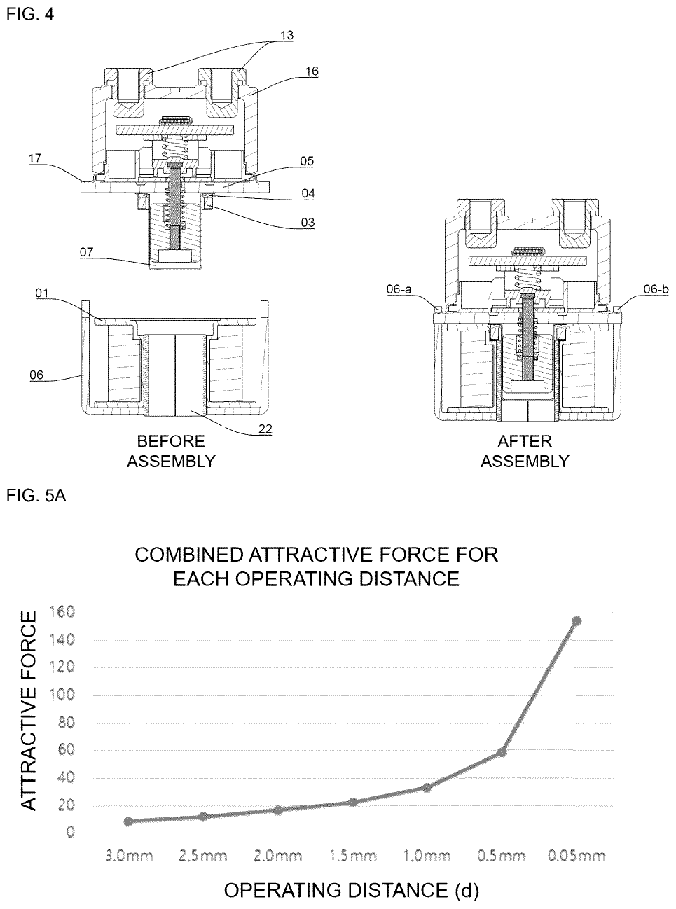

FIG. 4 is a drawing for explaining a structure in which a fixed core is adhered to a permanent magnet disposed on an end of a fixed core in an axial direction by a magnetic force of the permanent magnet in the axial direction of the permanent magnet, a plate washer made of a magnetic material is attached to the permanent magnet and a yoke plate is fixed to a yoke.

FIG. 4 is a drawing for explaining a structure in which, according to another method of assembling the permanent magnet 03, the washer 04 in a plate shape formed of a magnetic material is fitted into the cylinder 07 of the contact device airtight sealed with insulating gas, the permanent magnet 03 is assembled and fitted into the center of the bobbin 01, and left and right edges of the yoke plate 05 are seated in grooves defined by the protrusions 06-a and 06-b of the yoke 06 and fixed thereto by caulking.

Referring to FIG. 4, the fixed contacts 13, shield cup 17, the yoke plate 05, and the cylinder 07 may be hermetically welded to a ceramic housing 16, and the washer 04 in a plate shape and the permanent magnet 03 may be fitted onto the upper side of the cylinder 07 of the contact device filled with insulating gas, and may be inserted into the central through hole of the bobbin 01.

In this contact device assembly, the cylinder 07 of the contact device sealed with insulating gas may be inserted into the center portion of the bobbin 01 and fitted into and seated on grooves defined by the left protrusions 06-a and the right protrusions 06-b on both lateral surfaces of the U-shaped yoke 06, and the protrusions 06-a and 06-b of the yoke 06 may be fixed by caulking.

In addition, for example, when the permanent magnet 03 and the washer 04 in a plate shape are adhered to the yoke plate 05 and are accordingly prevented from being separated therefrom, the permanent magnet 03 and the washer 04 in a plate shape are fitted onto the outside of the cylinder 07 and assembled thereto, so there is no need to worry about the assembly being distorted or disassembled when the contact device stands and is inserted into the center of the bobbin 01.

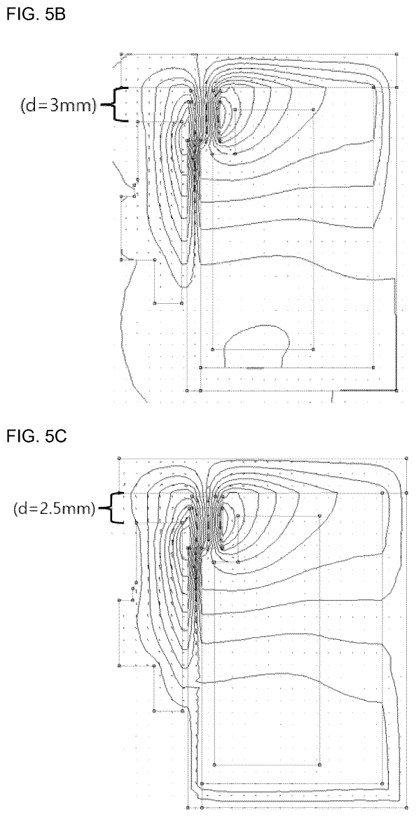

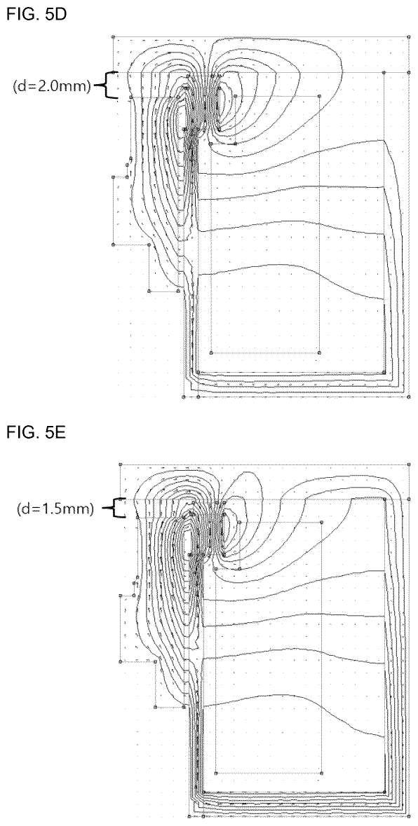

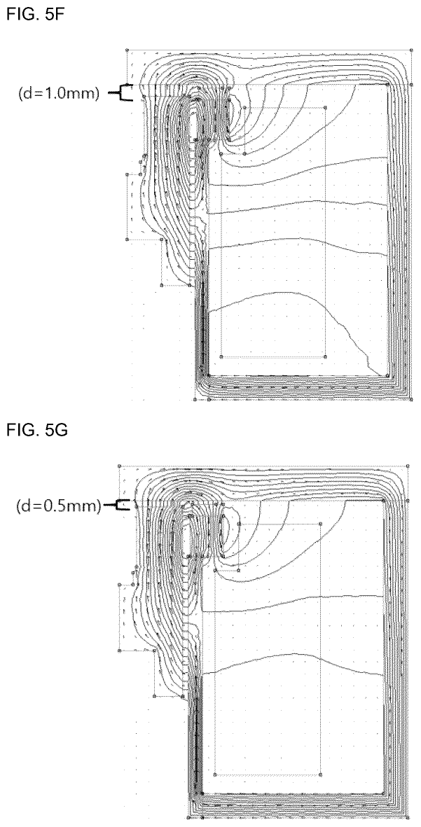

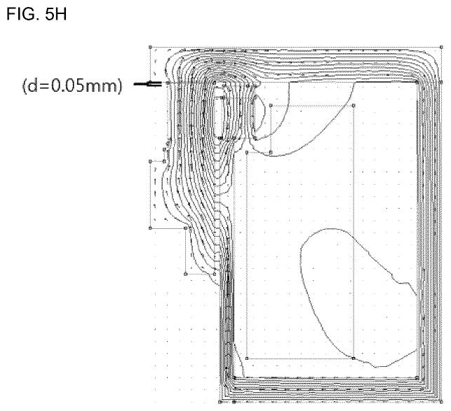

FIGS. 5A through 5H are diagrams for explaining a combined attractive force generated due to a magnetic flux of an electromagnet and a magnetic flux of a permanent magnet according to an operating distance of a movable core, according to an embodiment of the disclosure.

First, referring to FIG. 5A, it can be seen that the combined attractive force is 8.3 Nm when an operating distance d, which is a distance between the movable core 08 (and the yoke plate 05, is 3.0 mm, 11.5 Nm when the operating distance d is 2.5 mm, 16.1 Nm when the operating distance d is 2.0 mm, 22.1 Nm when the operating distance d is 1.5 mm, 32.8 Nm when the operating distance d is 1.0 mm, 58.3 Nm when the operating distance d is 0.5 mm, and 153.7 Nm when operating distance d is 0.05 mm, thereby creating a stronger composite magnetic flux as the movable core 08 becomes closer to the yoke plate 05, resulting in an increase in contact pressure.

Moreover, the volume of the permanent magnet 03 may be adjusted to create an optimal attractive force. This may be achieved by arranging the permanent magnet 03 on the upper cross-section 22-a of the fixed core 22 so as to minimize a leakage magnetic flux of the electromagnet and a leakage magnetic flux of the permanent magnet 03, and a contact device that reduces the volume of the electromagnet of an excitation coil part and reduces power consumption by using the electromagnet and the permanent magnet 03 in parallel may be realized.

FIGS. 5B through 5H show flows of the combined attractive forces due to the magnetic flux of the electromagnet and the magnetic flux of the permanent magnet when the operating distance d, which is the distance between the movable core 08 and the yoke plate 05, is 3.0 mm, 2.5 mm, 2.0 mm, 1.5 mm, 1.0 mm, 0.5 mm, and 0.05 mm, respectively.

As such, respective magnetic fluxes of the excitation coil 02 and the permanent magnet 03 may be generated and combined with each other at the same time when power of the excitation coil 02 is applied, so that the combined magnetic flux of the excitation coil 02 and the permanent magnet 03 may lower an operating voltage of the movable core 08, and the combined magnetic flux may increase as the movable core 08 gets closer to the yoke plate 05.

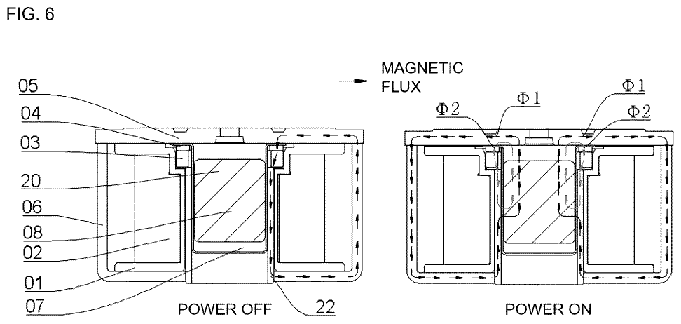

FIG. 6 is a view for explaining a closed loop of a combined magnetic flux of a coil and a permanent magnet at an initial time when a movable core applies power of the coil, according to an embodiment of the disclosure.

When coil manipulation power is applied to the coil terminal 21 extending from the excitation coil 02, a magnetic flux of an electromagnet flows from the fixed core 22 to the movable core 08 according to the principle of the electromagnet, and also a magnetic flux starting from the fixed core 22 flows to the permanent magnet 03 and moves from the permanent magnet 03 toward the movable core 08, and, eventually, the two magnetic fluxes Φ1 and Φ2 are summed to multiply and operate a magnetic attraction force, and, at the moment when the movable core 08 comes into contact with a yoke plate in an operation-stopped state, the magnetic flux Φ1 generated in the electromagnet of the excitation coil part may form a closed circuit in the order of the fixed core 22, the movable core 08, the yoke plate 05, and the yoke 06, and the magnetic flux Φ2 generated in the permanent magnet 03 may start from the N pole 03-b of the permanent magnet 03, which is a lower portion thereof, in an inward direction of the permanent magnet 03, pass through the fixed core 22, the movable core 08, and the yoke plate 05, and flow to the S pole 03-a of the permanent magnet 03 in a closed loop.

On the other hand, when manipulation power of the excitation coil 02 is off, the movable core 08 is separated from the fixed core 22 by the recovery spring 20 and moves downwards, in contrast with the above-described operation. At this time, the movable core 08 interlocked with the movable contact table 12 may move downward so that an electrical contact of a contact may be changed to an open circuit state. At this time, the yoke 06, the fixed core 22, the permanent magnet 03, the washer 04, and the yoke plate 05 may be connected to each other without a gap, so that a closed circuit of magnetic flux may be formed.

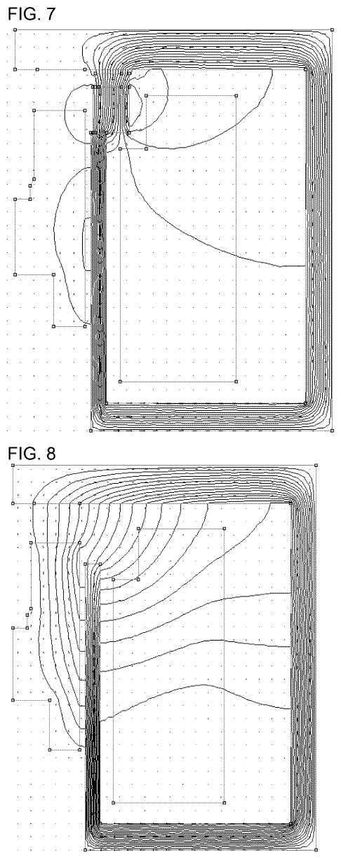

FIG. 7 is a diagram showing a closed loop of a magnetic flux Φ2 distribution by a permanent magnet before power is applied to a coil.

Referring to FIG. 7, the closed circuit loop is a loop that forms a completely closed circuit without gaps from the N pole of the permanent magnet 03 to the S pole thereof and from the S pole to the yoke plate 05, the yoke 06, the fixed core 22, and the N pole of the permanent magnet 03 through the washer 04 of the magnetic material.

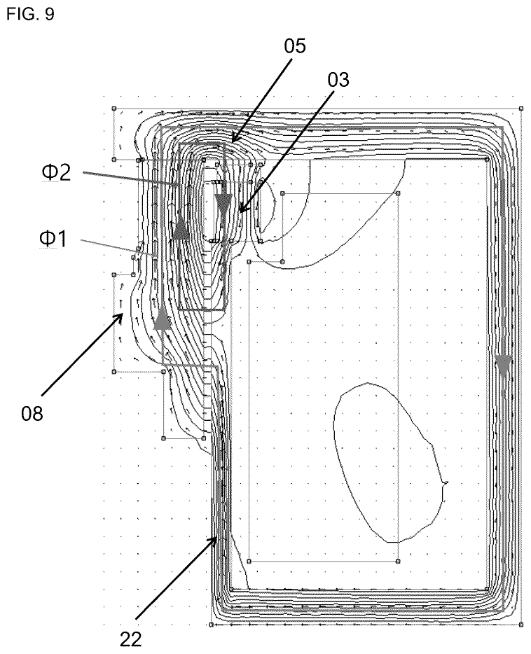

FIG. 8 is a diagram showing a magnetic flux distribution by the magnetic flux of an electromagnet without a permanent magnet in an initial state when power is applied to a coil.

Referring to FIG. 8, in a state where there is no permanent magnet, only a magnetic flux Φ1 due to the electromagnet of a coil part exists, and a magnetic flux Φ2 generated by the permanent magnet does not exist, so the attractive force of the movable core 08 acts weakly.

FIG. 9 is a diagram showing a magnetic flux distribution in which the magnetic flux Φ1 of the coil part and the magnetic flux Φ2 of the permanent magnet are synthesized to double the attractive force by applying power to the coil, according to an embodiment of the disclosure.

Referring to FIG. 9, the magnetic flux distribution represents a closed loop of a combined magnetic flux obtained by combining the magnetic flux Φ1 caused by the electromagnet of the coil part and the magnetic flux Φ2 generated from the permanent magnet after a complete operation through an upward movement of the movable core 08, and it can be seen that the magnetic flux 1 of the coil part and the magnetic flux Φ2 of the permanent magnet are combined and thus the attractive force is doubled.

At the moment when the movable core 08 comes into contact with the yoke plate 05 in an operation-stopped state, the magnetic flux Φ1 generated by the excitation coil 02 may form a closed circuit in the order of the fixed core 22, the movable core 08, the yoke plate 05, and the yoke 06, and the magnetic flux Φ2 generated in the permanent magnet 03 may start from the N pole 03-b of the permanent magnet 03, which is a lower portion thereof, in an inward direction of the permanent magnet 03, pass through the fixed core 22, the movable core 08 and the yoke plate 05, and flow to the S pole 03-a of the permanent magnet 03 in a closed loop.

The above-disclosed embodiments of the disclosure are merely examples, and thus the disclosure is not limited thereto. The scope of the disclosure should be interpreted by the following claims, and all technologies within the scope equivalent thereto should be interpreted as being included in the scope of the disclosure.

1. An electromagnet contact device comprising:
a coil wound around a bobbin;
a movable core that is driven by the coil in an axial direction;
a pair of fixed contacts for applying direct current (DC) power;
a movable contact table that operates in conjunction with the movable core and is movable up and down reciprocally so as to come into contact with the pair of fixed contacts;
a yoke including a magnetic material and configured to surround at least a portion of an exterior of the coil;
a yoke plate fixedly disposed on an upper side of the yoke;
a fixed core including a magnetic body and passing through a center portion of the bobbin and fixedly disposed by the yoke; and
a permanent magnet in a ring shape disposed on an upper side of the fixed core,
wherein a magnetic flux generated by the coil and a magnetic flux generated by the permanent magnet increase an attractive force of the movable core.

2. The electromagnet contact device of claim 1, wherein the permanent magnet has a magnetized surface in the axial direction.

3. The electromagnet contact device of claim 1, wherein the permanent magnet is attached to a cross-section of an upper side of the fixed core.

4. The electromagnet contact device of claim 3, wherein a washer in a plate shape made of a magnetic material is attached to an upper portion of the permanent magnet.

5. The electromagnet contact device of claim 4, wherein a closed circuit of a magnetic flux is formed without a gap between the yoke, the fixed core, the permanent magnet, the washer, and the yoke plate.

6. The electromagnet contact device of claim 1, wherein the permanent magnet includes a plurality of pieces.
